(19) United States
(12) Patent Application Publication
(10) Pub. No.: US 2014/0234613 A1
(43) Pub. Date: Aug. 21, 2014

(54) PROCESS FOR PRODUCING A RIGID POLYURETHANE-ISOCYANURATE FOAM

(71) Applicants: Hartmut Nefzger, Pulheim (DE); Jörg Hofmann, Krefeld (DE); Klaus Lorenz, Dormagen (DE); Stephanie Vogel, Langenfeld (DE); Reinhard Albers, Leverkusen (DE); Patrick Klasen, Vettweiss (DE)

(72) Inventors: Hartmut Nefzger, Pulheim (DE); Jörg Hofmann, Krefeld (DE); Klaus Lorenz, Dormagen (DE); Stephanie Vogel, Langenfeld (DE); Reinhard Albers, Leverkusen (DE); Patrick Klasen, Vettweiss (DE)

(73) Assignee: BAYER INTELLECTUAL PROPERTY GMBH, 40789 Monheim (DE)

(21) Appl. No.: 14/238,254

(22) PCT Filed: Aug. 16, 2012
(86) PCT No.: PCT/EP2012/065923

§ 371 Date: Apr. 25, 2014

(30) Foreign Application Priority Data
Aug. 16, 2011 (EP) 11306047.9

(51) Int. Cl. C08G 18/48

(52) U.S. Cl. CPC C08G 18/4895
USPC 428/319.1; 521/156; 521/129; 428/318.4; 428/319.7

(57) ABSTRACT

The invention provides a process for producing rigid polyurethane-polyisocyanurate foams using polyols having a high proportion of secondary hydroxyl end groups. The invention further relates to the rigid polyurethane-polyisocyanurate foams thus obtainable and to the use thereof in the production of composite elements from rigid polyurethane-polyisocyanurate foams and suitable outer layers. The invention further provides the composite elements thus obtainable.

The present invention relates to a process for producing rigid polyurethane-polyisocyanurate foams by using polyols having a high proportion of secondary hydroxyl end groups. The present invention further relates to rigid polyurethane-polyisocyanurate foams thus obtainable and also to their use in the production of composite elements from the rigid polyurethane-polyisocyanurate foams and suitable covering layers. The present invention further relates to the composite elements thus obtainable.

Rigid polyurethane-polyisocyanurate (PUR-PIR) foams are typically produced using at least one catalyst by reacting a polyol component with an isocyanate component in the presence of a blowing agent. Additives such as foam stabilizers and flame retardants can further also be added. Rigid PUR-PIR foams have excellent thermal stability and improved fire properties compared with other rigid foams such as rigid PUR foams for example. These improved properties are ascribed to isocyanurate structural elements.

Catalysts used are frequently carboxylate salts such as, for example, alkali metal carboxylates. However, their use often leads to processing problems which can lead to severe difficulties in both continuous foaming systems and in batch processes. These processing problems are ultimately attributable to the fact that the onset temperature for urethane group formation is lower than that for isocyanurate group formation. At the beginning of the urethanization reaction, the reaction mixture heats up as a result of the exothermic nature of the reaction. The trimerization reaction (formation of isocyanurate groups) ensues on attainment of a certain temperature, generally on the order of 60° C. A plot of the height of rise of the foam versus time in such cases shows a bimodal (“stepped”) reaction profile, i.e., the rate of rise passes through two maxima: the first maximum corresponds to the onset of the urethanization reaction and the second to that of the trimerization reaction. So the foam ultimately expands at two different rates during foaming. Properties can suffer as a result. Rigid PUR-PIR foams are generally applied to firm supports, e.g., metallic covering layers. One possible effect of a bimodal reaction profile at this stage is that the bond between the foam and the carrier material is severely disrupted, which in some instances can lead all the way to the foam tearing off from the support. In the case of foamed articles in rigid PUR-PIR foam, such a bimodal reaction and rise profile can lead to foam back-flow at the end of the flow path of the flowing foam, causing voiding and air entrapments. Either is undesirable because of the adverse effects on the properties of the foamed article, such as those of the foamed article, such as the insulating performance, the adherence between the foam and the support and also the visual surface quality (in the case of metal composite elements, for example).

To solve this problem, EP 1 878 493 A1 proposes the use of specific carbanionic catalysts. These carbanionic catalysts can be described by the general formula

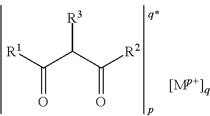

where R¹ to R³, M, p and q are each as defined in section [0006] of said document. The catalysts in question accordingly have an acetylacetonato carbanion unit. The disadvantage with this process is the high cost of carbanionic catalysts, compared with the catalysts otherwise customary in the prior art, and also the limited commercial availability of carbanionic catalysts.

There was accordingly a need for a process for producing rigid PUR-PIR foams which without using special, costly catalysts provides a simple way to ensure a very uniform reaction profile in order that the abovementioned disadvantages of a bimodal reaction profile may be avoided as far as possible.

To meet this need, the present invention provides a process for producing rigid PUR-PIR foams by foaming up a polyol component comprising polyester polyols having secondary hydroxyl end groups in a proportion of preferably at least 50%, based on all hydroxyl end groups present, with an isocyanate component in the presence of a blowing agent and of a catalyst, excluding carbanionic catalysts. The rigid PUR-PIR foams thus obtainable are likewise subjects of the present invention. The present invention more particularly provides a process wherein foaming takes place against at least one covering layer to obtain a composite element comprising at least one covering layer and the rigid PUR-PIR foam. The present invention further provides composite elements obtainable by the process of the present invention. The process of the present invention has a substantially monomodal reaction profile at the foaming stage to obtain rigid PUR-PIR foams and composite elements which are substantially free from the abovementioned disadvantages (poor adherence of the foam to the covering layer, reduced insulation performance, reduced surface finish and so on).

According to the present invention, the polyester polyols having secondary hydroxyl end groups are prepared by addition of epoxides of general formula (1),

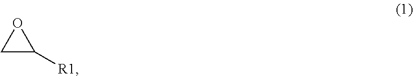

where R1 represents alkyl or aryl, onto “acidic” polyesters, i.e., polyesters having carboxyl end groups. Such a process for preparing polyester polyols having secondary hydroxyl end groups is described in detail in the patent application WO 2010/127 823 A2. Said application further mentions the use of such polyols in the production of polyurethane polymers without, however, providing details such as, for example, the composition of the polymer or suitable fields of use.

WO 2011/000 546 A1 relates in significantly more detail than WO 2010/127 823 A2 to the use of polyester polyols having secondary hydroxyl end groups obtained by addition of epoxides onto “acidic” polyesters in the production of polyurethane polymers where the emphasis is on flexible polyurethane (PUR) foams. The polyisocyanurate reaction and its special features (see the above explanation regarding the bimodal reaction profile) are not discussed in this document. As one skilled in the art would know, there are fundamental differences between the production of a flexible PUR foam and the production of a rigid PUR-PIR foam. In addition to the aforementioned problematics of the bimodal reaction profile which do not present in that form in the production of a flexible PUR foam, there are yet further differences which are important. For instance, rigid foams are by virtue of their typical performance profiles (e.g., as insulating material or part of an engineered element in building construction) predominantly or completely closed-cell, in contradistinction to flexible foams. Flexible foams have to meet completely different requirements owing to the fundamentally different field of use (in the comfort sector, for instance for seating or mattresses). The specific requirements of rigid foams generally necessitate the use of a physical blowing agent, while flexible foams are predominantly or even exclusively produced using water as chemical blowing agent. Polyols used in the production of rigid foams generally have a shorter chain length than those used in the production of flexible foams. It is clear even from this incomplete enumeration of differences that the engineering and chemical aspects which apply to either the rigid foam field or to the flexible foam field cannot readily be applied to whichever is the other field.

Polyols having secondary hydroxyl end groups as reaction partners for isocyanates are further discussed in the following documents:

GB 1,108,013 discloses the use of a hydroxyl-containing polyester in the production of polyurethane foams (cf. claim 1). The production of PUR-PIR foams is not disclosed in GB 1,108,013. The hydroxyl-containing polyester is obtained by reaction of phthalic anhydride, or of a substituted phthalic anhydride, with a polyol containing at least three hydroxyl groups and an epoxide. Propylene oxide is mentioned in Example 1. The ester constituents in the hydroxyl-containing polyesters obtained in this way are thus predominantly (preferably to an extent of at least 80%, cf. claim 2) to wholly phthalic acid units (for, as the case may be, substituted phthalic acid units). A further consequence of the method of making the hydroxyl-containing polyester in the manner described in GB 1,108,013 is that the structural elements obtained by opening of propylene oxide (i.e., —O—CH₂—CH(O—)—CH₃) are found not just at the end of the chain (where they lead to the formation of secondary hydroxyl end groups), but also in the core of the polyester, i.e., short alkyl side groups are an inevitable constituent of the polyester. Compared with polyurethanes obtained from unbranched α,ω-diols, the properties of polyurethanes obtained from polyesters of this type are often disadvantageously altered as a consequence of the numerous short alkyl side groups. There is in particular the increased viscosity which, at a molecular level, results from the restricted free rotatability due to the presence of the alkyl side groups compared with virtually free rotatability in the absence of alkyl side groups. Increased viscosity is always a processing disadvantage, not just logistically, but also in relation to the foaming operation itself, especially when the molds to be filled are complicated and have undercuts or else are large and have long flow paths.

U.S. Pat. No. 4,647,595 discloses a process for producing urethane-modified polyisocyanurate (PIR) foams (cf. claim 1). The polyol component used comprises a polyester ether polyol. The polyester ether polyol is obtained by reacting an aromatic carboxylic anhydride with an epoxide and an alcohol component. The reaction conditions disclosed in U.S. Pat. No. 4,647,595 are such that the above-described problematics relating to the presence of numerous short-chain alkyl side groups are also an issue here.

EP 0 086 309 A1 relates to coating compositions obtained using polyhydroxy oligomers. The coating compositions find use as automotive topcoats (cf. the abstract). The polyhydroxy oligomers are obtained by reacting an acidic ester with an epoxide, while the acidic ester is in turn made by reacting an aliphatic branched C₃-C₁₀ diol with an alkylhexahydrophthalic anhydride used in stoichiometric excess (cf. claim 1). When propylene oxide is used as epoxide (as disclosed in Example 10), the polyhydroxy oligomer obtained accordingly has secondary hydroxyl end groups. The coating composition comprises such a polyhydroxy oligomer, a crosslinking agent and a hydroxyl-functional additive (cf. claim 11). A polyisocyanate can be used as crosslinking agent (cf. claim 14). The use of polyester polyols having secondary hydroxyl end groups in the production of rigid PUR-PIR foams is not disclosed in EP 0 086 309 A1. In fact, it is not foams with which this document is concerned, but coatings useful as paints.

None of the above-cited prior art documents is thus concerned with the use of polyester polyols having secondary hydroxyl end groups in the production of rigid PUR-PIR foams to avoid a bimodal reaction profile. The present invention, as detailed hereinbelow, offers a simple way to efficiently ameliorate the introductorily described issues relating to nonuniform reaction profiles in the production of rigid PUR-PIR foams.

The invention provides a process for producing a rigid polyurethane-polyisocyanurate foam C comprising the steps of
(I) reacting a polyester comprising carboxyl end groups with an epoxide of general formula (1),

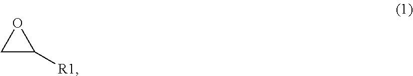

where R1 represents alkyl or aryl,
by obeying a molar ratio of epoxy groups to carboxyl end groups at between 0.8:1 and 50:1, preferably at between 1:1 and 20:1 and more preferably at between 1.05:1 and 5:1 to obtain a polyester polyol having secondary hydroxyl end groups A1a which has a functionality of 1.8 to 6.5, preferably 1.8 to 3.0, and a hydroxyl number of 15 mg KOH/g to 500 mg KOH/g, preferably 100 to 350 and more preferably 150 to 350;
(II) foaming at isocyanate indexes of 180 to 400, preferably of 200 to 380 and more preferably of 220 to 360,
   (i) a polyol component A1 comprising A1a
   with
   (ii) an isocyanate component B comprising
      a) at least one isocyanate B1 selected from the group consisting of:
         tolylene diisocyanate (TDI), diphenylmethane diisocyanate (MDI), xylylene diisocyanate, naphthylene diisocyanate, hexamethylene diisocyanate, diisocyanatodicyclohexylmethane and isophorone diisocyanate, preferably diphenylmethane diisocyanate (MDI) and polyphenylene polymethylene polyisocyanate (PMDI),
         or
      b) an isocyanate-terminated prepolymer B2 prepared from at least a polyisocyanate B1 and an isocyanate-reactive compound,
      or
      c) mixtures of B1 and B2,
   in the presence of
   (iii) at least one blowing agent A2, and
   (iv) at least one catalyst A3, except that carbanionic catalysts shall be excluded.

The term carboxyl end groups comprehends COO⁻ end groups as well as COOH end groups. COOH end groups are preferred, i.e., the polyesters comprising carboxyl end groups are preferably polyesters comprising carboxylic acid end groups.

The hydroxyl number of a substance indicates the potassium hydroxide quantity in milligrams which is equivalent to the acetic acid quantity bound by one gram of the substance on acetylation, and is determined in accordance with German standard specification DIN 53240 as of December 1971.

Functionality in the context of the present invention refers to the theoretical functionality as computed from the known reactants and their quantitative ratios.

The isocyanate index is the quotient formed between the actually used amount of substance [moles] of isocyanate groups and the amount of substance [moles] of isocyanate groups which is stoichiometrically needed for complete conversion of all isocyanate-reactive groups, multiplied by 100. Since the conversion of one mole of an isocyanate-reactive group requires one mole of an isocyanate group, the following equation applies:

isocyanate index=(moles of isocyanate groups/moles of isocyanate-reactive groups)×100

The term blowing agent in the context of the present invention comprehends both physical and chemical blowing agents. Chemical blowing agents are compounds which form gaseous products by reaction with isocyanate. By contrast, physical blowing agents are such compounds as are used in liquid or gaseous form and do not enter into a chemical reaction with the isocyanate.

Carbanionic catalysts for the purposes of the present invention are catalysts comprising a structural unit having (in one limiting structure at least) a formally negatively charged carbon atom. The acetylacetonato ligand, for example, is deemed a carbanion in the context of the present invention because it can be reasonably posited to have a limiting structure featuring a formally negatively charged carbon atom, namely II:

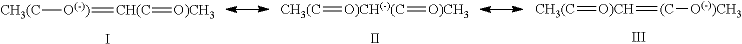

By contrast, the acetate ligand, for example, is not deemed a carbanion because the negative charged is formally localized on an oxygen atom in both reasonable limiting structures.

Rigid PUR/PIR foams C within the meaning of the present invention are particularly those PUR/PIR foams whose apparent density, as defined in DIN EN ISO 3386-1-98 as of September 2010, is in the range from 15 kg/m³ to 300 kg/m³ and whose compressive strength, as defined in DIN EN 826 as of May 1996, is in the range from 0.1 MPa to 3 MPa.

Embodiments of the present invention are described hereinbelow, while the individual embodiments can be freely combined with each other unless the context clearly suggests otherwise.

Any polyester comprising carboxyl end groups is in principle useful for reacting with the epoxide (1) in step (I) provided its use leads to a polyol A1a which satisfies the functionality and hydroxyl number requirements of the present invention. The preparation of such polyesters comprising carboxyl end groups (hereinafter also called polyester carboxylates) is known per se and is preferably effected by polycondensation of low molecular weight polyols and low molecular weight polycarboxylic acids, including anhydrides thereof and alkyl esters thereof. Hydroxy carboxylic acids including their inner anhydrides (lactones) can further be used or co-used. The recited groups on carboxylic acids or carboxylic acid derivatives are hereinbelow also summarily referred to as carboxylic acid equivalents.

Useful polyester carboxylates for the present invention have predominantly carboxyl end groups. In contrast, they only have a very low level of hydroxyl end groups. Preferably from 80 mol % to 100 mol % and more preferably from 90 mol % to 100 mol % of all end groups are carboxyl groups. Suitable polyester carboxylates can have molecular masses in the range from 250 Da to 10 000 Da, preferably in the range from 300 Da to 6000 Da. Irrespective of the above, the number of carboxyl end groups in the polyester carboxylate can be 2, 3, 4, 5 or 6. The average functionality of polyester carboxylates is preferably ≧2 to ≦3.

Low molecular weight polyols useful for forming the polyester carboxylates preferably have hydroxyl functionalities of ≧2 to ≦8. Their number of carbon atoms is preferably between 2 and 36 and more preferably between 2 and 12. It is preferable for at least 90 mol % and more preferable for 100 mol % of all alcohol groups of the alcohol component from which the polyester comprising carboxyl end groups is constructed to derive from unbranched α,ω-diols (based on a 100 mol % total of alcohol groups in the alcohol component from which the polyester comprising carboxyl end groups is constructed). Very particular preference is given to polyols from the group:
ethylene glycol and diethylene glycol including higher homologs thereof, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, including higher homologs thereof.

It will be appreciated that mixtures of these polyols with each other or with further polyols can also be used, in which case the recited polyols preferably contribute not less than 90 mol % of all hydroxyl groups in the latter scenario.

It is in principle possible, although not preferable, to additionally use polyols from the group:
1,2-propanediol, dipropylene glycol and its higher homologs, 2-methyl-1,3-propanediol, neopentyl glycol, 3-methyl-1,5-pentanediol, glycerol, pentaerythritol, 1,1,1-trimethylolpropane and carbohydrates having 5 to 12 carbon atoms (such as isosorbide for example).

These can likewise be mixed with each other or with further polyols. In any event, if using these polyols, however, the unbranched α,ω-diols characterized above as very particularly preferred contribute not less than 90 mol % of all hydroxyl groups.

Low molecular weight polycarboxylic acid equivalents useful for forming the polyester carboxylates have particularly from 2 to 36 and preferably from 2 to 12 carbon atoms. The low molecular weight polycarboxylic acid equivalents can be aliphatic or aromatic. They are preferably selected from the group:
succinic acid, fumaric acid, maleic acid, maleic anhydride, glutaric acid, adipic acid, sebacic acid, suberic acid, azelaic acid, 1,10-decanedicarboxylic acid, 1,12-dodecanedicarboxylic acid, phthalic acid, phthalic anhydride, isophthalic acid, terephthalic acid, pyromellitic acid and trimellitic acid.

It will be appreciated that mixtures of these low molecular weight polycarboxylic acid equivalents with each other or with further polycarboxylic acid equivalents can also be used, in which case the recited polycarboxylic acids preferably contribute not less than 90 mol % of all carboxyl groups in the latter scenario.

When hydroxy carboxylic acids including their inner anhydrides (lactones) are used or co-used, it is preferable to use caprolactone and/or 6-hydroxycaproic acid.

In a very particularly preferred embodiment, the polyester comprising carboxyl end groups is obtained from the reaction of

(i) at least one alcohol selected from the group consisting of
ethylene glycol, diethylene glycol, polyethylene glycol, 1,2-propylene glycol, dipropylene glycol, 1,3-propanediol, 1,4-butanediol, 1,6-hexanediol, 1,8-octanediol, 1,10-decanediol, 1,12-dodecanediol, 2-methyl-1,3-propanediol, neopentyl glycol, 3-methyl-1,5-pentanediol, glycerol, pcntaerythritol and 1,1,1-trimethylolpropane,

with

(ii) at least one carboxylic acid equivalent selected from the group consisting of
succinic acid, fumaric acid, maleic acid, maleic anhydride, glutaric acid, adipic acid, sebacic acid, 1,10-decanedicarboxylic acid, 1,12-dodecanedicarboxylic acid, phthalic acid, phthalic anhydride, isophthalic acid, terephthalic acid, pyromellitic acid, trimellitic acid and caprolactone.

The polycondensation of alcohols and carboxylic acid equivalents is preferably carried out without catalyst, but can also be catalyzed using the catalysts known to one skilled in the art. The polycondensation can be carried out according to familiar methods, for example at elevated temperature, in vacuo, as azeotropic esterification or by the nitrogen-blowing method. In any event, the polycondensation is not discontinued at a certain stage, but is carried on (by removing the water formed) to very complete conversion of the OH groups of the alcohol to form carboxyl end groups.

It can be sensible in certain scenarios to conduct the step (I) preparation of the polyester comprising carboxyl end groups in two steps, especially in the case of using carboxylic acid equivalents which tend to sublime (as is the case with, for example, phthalic acid, which tends to precipitate in comparatively low-temperature regions in a manufacturing plant). An intermediate having hydroxyl end groups is made in the first step and converted with an anhydride into the desired polyester carboxylate in a second step. In this embodiment, the invention provides in particular a process wherein the preparation of the polyester comprising carboxyl end groups which is used in step (l) comprises the steps of:
(i) condensing at least one alcohol selected from the group consisting of
   ethylene glycol, diethylene glycol, polyethylene glycol, 1,2-propylene glycol, dipropylene glycol, 1,3-propanediol, 1,4-butanediol, 1,6-hexanediol, 1,8-octanediol, 1,10-decanediol, 1,12-dodecanediol, 2-methyl-1,3-propanediol, neopentyl glycol, 3-methyl-1,5-pentanediol, glycerol, pentaerythritol and 1,1,1-trimethylolpropane,
   with
   at least one carboxylic acid equivalent selected from the group consisting of
   succinic acid, fumaric acid, maleic acid, maleic anhydride, glutaric acid, adipic acid, sebacic acid, 1,10-decanedicarboxylic acid, 1,12-dodecanedicarboxylic acid, phthalic acid, phthalic anhydride, isophthalic acid, terephthalic acid, pyromellitic acid, trimellitic acid and caprolactone,
   while choosing the molar ratio of alcohol(s) to carboxylic acid equivalent(s) such that a process product having terminal alcohol groups is obtained;
(ii) reacting the process product obtained in (i) with at least one carboxylic anhydride selected from the group consisting of
   phthalic anhydride, maleic anhydride, glutaric anhydride and succinic anhydride, preferably phthalic anhydride.

Preferably, step (i) is carried out at a temperature T(i) of 150° C. to 250° C. and step (ii) is carried out at a temperature T(ii) of 120° C. to 250° C., preferably of 120° C. to 200° C. and more preferably of 120° C. to 180° C. The lower the temperature in step (ii), the smaller the risk of unwanted transesterifications.

This embodiment is especially advantageous for those applications of rigid PUR/PIR foams where the fire behavior is a particular concern. The two-step synthesis described is very useful for producing polyester carboxylates where the ester constituents are predominantly or wholly phthalic acid groups. It is known that phthalic acid has an extremely favorable effect on the fire behavior.

The epoxide of general formula (1) is a terminal epoxide having an R1 substituent which may be alkyl or aryl. The term “alkyl” throughout the entire invention comprises in general substituents from the group n-alkyl, branched alkyl and/or cycloalkyl. The term “aryl” throughout the entire invention comprises in general substituents from the group mononuclear carbo- or heteroaryl substituents and/or polynuclear carbo- or heteroaryl substituents. In a particularly preferred embodiment of the process according to the present invention, R1 in general formula (1) is
methyl, ethyl, n-propyl, isopropyl, n-butyl, sec-butyl, isobutyl, tert-butyl, cyclohexyl or phenyl.

In one embodiment of the process according to the present invention, the polyester comprising carboxyl end groups is prepared by using ≧1.03 mol to ≦1.90 mol of carboxyl group equivalents per mole of alcohol hydroxyl groups. The excess of carboxyl group equivalents ensures that a very predominant proportion of the end groups of the polyester, or even all end groups, are carboxyl groups. The excess of carboxyl groups can also be ≧1.04 mol to ≦1.85 mol or ≧1.05 mol to ≦1.5 mol per mole of hydroxyl groups.

The reaction of the polyester comprising carboxyl end groups with the epoxide (1) to form the polyester polyol having secondary hydroxyl end groups A1a is carried out in a conventional manner. The molar ratio of epoxide to carboxyl end group in the process of the present invention is between 0.8:1 and 50:1, preferably between 1:1 and 20:1 and more preferably between 1.05:1 and 5:1.

In one preferred embodiment, the invention provides a process wherein the foaming step utilizes a polyester polyol A1a in which the molar ratio of primary hydroxyl end groups to secondary hydroxyl end groups is between 0:1 and 1:1, preferably between 0.01:1 and 0.66:1. This is to be understood as meaning the molar ratio in the polyester polyol A1a as a whole, i.e., not in relation to any one molecule. The ratio can be determined using ¹H NMR spectroscopy for example. The greater the proportion of secondary hydroxyl groups in the polyester polyol, the slower the reaction rate in foaming and the simpler the achievement of a uniform reaction profile.

In a further embodiment of the process according to the present invention, the polyester carboxylate is prepared immediately prior to the reaction with the epoxide of general formula (1). So the reaction with the epoxide to form A1a takes place immediately following the preparation of the polyester carboxylate. Advantageously, the reaction is carried out by adding the epoxide to the reaction mixture from the polyester synthesis. This advantageously takes place in the same manufacturing plant. Production time is saved as a result.

In a further embodiment of the process according to the present invention, the reaction with the epoxide of general formula (1) to prepare the polyester polyols A1a takes place at a temperature of ≧70° C. to ≦150° C. The reaction temperature may preferably be ≧80° C. to ≦130° C.

The reaction of the epoxide (1) with the polyester carboxylate is preferably carried out in the presence of a catalyst comprising at least one nitrogen atom in the molecule. The amount of this nitrogenous catalyst can be for example between 10 ppm and 10 000 ppm, preferably between 50 ppm and 5000 ppm and more preferably between 100 ppm to ≦2000 ppm, based on the overall mass of the reaction batch.

Said polyester polyol having secondary hydroxyl end groups A1a is preferably prepared in the presence of at least one catalyst selected from:

(i) amines of general formula (2):

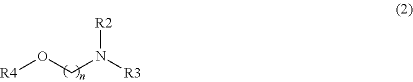

where
R2 and R3 are each independently hydrogen, alkyl or aryl;
or

R2 and R3 combine with the nitrogen atom bearing them to form an aliphatic, unsaturated or aromatic heterocycle;
n is an integer from 1 to 10;
R4 is hydrogen, alkyl or aryl; or
R4 represents —(CH₂)ₓ—N(R41)(R42), where:
R41 and R42 are each independently hydrogen, alkyl or aryl; or
R41 and R42 combine with the nitrogen atom bearing them to form an aliphatic, unsaturated or aromatic heterocycle;
x is an integer from 1 to 10;

or

(ii) amines of general formula (3):

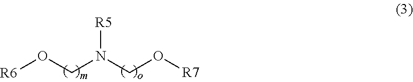

where
R5 is hydrogen, alkyl or aryl;
R6 and R7 are each independently hydrogen, alkyl or aryl;
m and o are each independently an integer from 1 to 10;

or

(iii) nitrogen compounds selected from the group consisting of:
diazabicyclo[2.2.2]octane, diazabicyclo[5.4.0]undec-7-ene, dialkylbenzylamine, dimethylpiperazine, 2,2′-dimorpholinyldiethyl ether, pyridine;

or

(iv) mixtures of catalysts from two or more of groups (i) to (iii).

Amines of general formula (2) can in the widest sense be described as amino alcohols or ethers thereof. When R4 is hydrogen, the catalysts are incorporable in a polyurethane matrix when the polyester polyol is reacted with a polyisocyanate. This is advantageous to prevent the catalyst, which in the case of amines can be associated with disadvantageous odor problems, from migrating to the polyurethane surface, i.e., the issue of “fogging” or VOC (volatile organic compounds).

Amines of general formula (3) can in the widest sense be described as amino (bis)alcohols or ethers thereof. When R6 or R7 is hydrogen, these catalysts are likewise incorporable in a polyurethane matrix.

The catalysts in question can influence the reaction of the carboxyl groups with the epoxide such that a higher proportion of desired secondary OH end groups in the polyester polyol is obtained.

Compounds of this type can in certain versions also be used as so-called blowing catalysts, i.e., they preferentially catalyze the reaction of the isocyanate groups with water to form carbon dioxide as well as to a minor extent their reaction with hydroxyl groups to form urethane groups. Therefore, this composition can immediately be further used in the production of polyurethanes.

In one particularly preferred embodiment, the invention provides a process wherein in general formula (2)
R2 and R3 are each methyl, R4 is hydrogen and n is =2, i.e., catalyst (2) is N,N-dimethylethanolamine, or
R2 and R3 are each methyl, R4 is —(CH₂)₂—N(CH₃)₂ and n is =2, i.e., catalyst (2) is bis(2-(dimethylamino)ethyl)ether,

and wherein in general formula (3)
R5 is methyl, R6 and R7 are each hydrogen, m is =2 and o is =2, i.e., catalyst (3) is N-methyldiethanolamine.

The reaction of the carboxyl groups of the polyester with the epoxide proceeds with ring opening to produce primary or secondary alcohols depending on the site of attack on the epoxy ring. Preferably, ≧80%, ≧90% or ≧95% of the carboxyl groups react with the epoxide.

Polyol component A1 may comprise not only A1a but additionally further polyols. In this case, the proportion of A1a is preferably at least 40% by mass, more preferably at least 50% by mass and most preferably at least 60% by mass, all based on the overall mass of A1, i.e., the sum total of the masses of all the polyols used. In this preferred embodiment, therefore, the invention provides a process wherein the polyol component A1 used in step (II) comprises not only the polyester polyol having secondary hydroxyl end groups A1a but additionally at least one aliphatic polyether polyol A1b having a hydroxyl number between 15 mg KOH/g and 500 mg KOH/g, preferably of 20 mg KOH/g to 450 mg KOH/g and a functionality of 1.5 to 5.5, preferably of 1.8 to 3.5. Two or more aliphatic polyether polyols A1b can also be used. Preference is given to using two aliphatic polyether polyols A1b(I) and A1b(II) which both meet the aforementioned hydroxyl number and functionality requirements.

Useful aliphatic polyether polyols A1b for the purposes of the present invention are obtainable by alkoxylation of at least bifunctional starter compounds, preferably amines, alcohols or aminoalcohols, preferably by using alkali metal hydroxide or double metal cyanide catalysts.

The use of further polyols besides A1a or besides A1a and A1b is also conceivable. Possibilities include in particular polyether carbonate polyols A1c as obtainable for example by catalytic reaction of epoxides and carbon dioxide in the presence of H-functional starter substances (see EP-A-2 046 861 for example). These polyether carbonate polyols generally have a functionality of 2 to 8, preferably of 2 to 7 and more preferably of 2 to 6. The number-averaged molar mass is preferably in the range from 400 g/mol to 10 000 g/mol and more preferably in the range from 500 g/mol to 6000 g/mol.

The isocyanates B1 are initially not further restricted with regard to the isomers of individual members of the group. For instance, 2,4-TDI or 2,6-TDI can be used as well as the 2,2′-, 2,4′- and 4,4′-isomers in the case of MDI. Polyphenylene polymethylene polyisocyanate may contain 6, 7, 8, 9 or 10 MDI monomers, for example.

The prepolymers B2 are reaction products of the isocyanates B1 with isocyanate-reactive compounds in stoichiometric deficiency. Examples of suitable isocyanate-reactive compounds include polyols, especially polyether polyols based on propylene oxides and/or ethylene oxide. However, polyester polyols and polyetherester polyols can also be used.

Useful blowing agents A2 include particularly water, cyclopentane, n-pentane, isopentane, hydrofluorocarbons, e.g., “HFC 245fa” (1,1,1,3,3-pentafluoropropane), “HFC 365mfc” (1,1,1,3,3-pentafluorobutane) or mixtures thereof with “HFC 227ea” (heptafluoropropane), and partially halogenated alkenes having 3 or 4 carbon atoms.

Useful catalysts A3 include particularly triethylenediamine, N,N-dimethylcyclohexylamine, tetramethylenediamine, 1-methyl-4-dimethylaminoethylpiperazine, triethylamine, tributylamine, dimethylbenzylamine, dicyclohexylmethylamine, N,N′,N″-tris(dimethylaminopropyl)hexahydrotriazine, tris(dimethylaminopropyl)amine, tris(dimethylaminomethyl)phenol, dimethylaminopropylformamide, N,N,N′,N′-tetramethylethylenediamine, N,N,N′,N′-tetramethylbutanediamine, tetramethylhexanediamine, pentamethyldiethylenetriamine, pentamethyldipropylenetriamine, tetramethyldiaminoethyl ether, dimethylpiperazine, 1,2-dimethylimidazole, 1-azabicyclo[3.3.0]octane, bis(dimethylaminopropyl)urea, N-methylmorpholine, N-ethylmorpholine, N-cyclohexylmorpholine, 2,3-dimethyl-3,4,5,6-tetrahydropyrimidine, triethanolamine, diethanolamine, triisopropanolamine, N-methyldiethanolamine, N-ethyldiethanolamine, dimethylethanolamine, tin(II) acetate, tin(II) octoate, tin(II) ethylhexoate, tin(II) laurate, dibutyltin diacetate, dibutyltin dilaurate, dibutyltin maleate, dioctyltin diacetate, tris(N,N-dimethylaminopropyl)-s-hexahydrotriazine, tetramethylammonium hydroxide, sodium N-[(2-hydroxy-5-nonylphenyl)methyl]-N-methylaminoacetate, sodium acetate, sodium octoate, potassium acetate, potassium octoate and sodium hydroxide.

In particular, it is preferable in the process of the present invention for catalyst A3 to be selected from the group consisting of:
triethylenediamine, N,N-dimethylcyclohexylamine, tetramethylenediamine, 1-methyl-4-dimethylaminoethylpiperazine, triethylamine, tributylamine, dimethylbenzylamine, dicyclohexylmethylamine, N,N′,N″-tris(dimethylaminopropyl)hexahydrotriazine, tris(dimethylaminopropyl)amine, tris(dimethylaminomethyl)phenol, dimethylaminopropylformamide, N,N,N′,N′-tetramethylethylenediamine, N,N,N′,N′-tetramethylbutanediamine, tetramethylhexanediamine, pentamethyldiethylenetriamine, pentamethyldipropylenetriamine, tetramethyldiaminoethyl ether, dimethylpiperazine, 1,2-dimethylimidazole, 1-azabicyclo[3.3.0]octane, bis(dimethylaminopropyl)urea, N-methylmorpholine, N-ethylmorpholine, N-cyclohexylmorpholine, 2,3-dimethyl-3,4,5,6-tetrahydropyrimidine, triethanolamine, diethanolamine, triisopropanolamine, N-methyldiethanolamine, N-ethyldiethanolamine, dimethylethanolamine, tin(II) acetate, tin(II) octoate, tin(II) ethylhexoate, tin(II) laurate, dibutyltin diacetate, dibutyltin dilaurate, dibutyltin maleate, dioctyltin diacetate, tris(N,N-dimethylaminopropyl)-s-hexahydrotriazine, tetramethylammonium hydroxide, sodium N-[(2-hydroxy-5-nonylphenyl)methyl]-N-methylaminoacetate, sodium acetate, sodium octoate, potassium acetate, potassium octoate and sodium hydroxide,

and wherein said blowing agent A2 is selected from the group consisting of:
water, cyclopentane, n-pentane, isopentane, hydrofluorocarbons and partially halogenated alkenes having 3 or 4 carbon atoms, where cyclopentane, n-pentane and isopentane are preferable and cyclopentane is particularly preferable.

The rigid PUR/PIR foams C can further be produced according to the present invention with the assistance of auxiliary and added-substance materials known to one skilled in the art, examples being flame retardants A4, foam stabilizers A5, etc.

It is particularly preferable for components A1 to A5 and optionally further auxiliary and added-substance materials (such as, for example, emulsifiers, fillers) to be mixed into an isocyanate-reactive composition A before the foaming with isocyanate component B. In this embodiment, the invention provides a process wherein step (II) is carried out in the presence of

(v) at least one flame retardant A4, and

(vi) at least one foam stabilizer A5,

by first preparing an isocyanate-reactive composition A comprising, preferably consisting of, said components A1 to A5 by mixing said components in any desired order in an A:A2 mass ratio of 2.5:1 to 25:1 to obtain a solution of A2 in A or an emulsion of A2 in A, and then foaming up said isocyanate-reactive composition A with said isocyanate component B to form said rigid polyurethane-polyisocyanurate foam C. The mass fraction of polyol component A1 in the isocyanate-reactive component A is preferably between 55% by mass and 85% by mass, more preferably between 60% by mass and 80% by mass and most preferably between 65% by mass and 75% by mass.

According to the present invention, the foaming of the individual components into the rigid PUR/PIR foam C is carried out at isocyanate indices of 180 to 400, preferably of 200 to 380 and more preferably of 220 to 360. The isocyanate index chosen determines the proportion of isocyanurate structural elements. The proportion thereof increases with increasing isocyanate index. In general, a high isocyanate index has an improving effect on the fire behavior, but an adverse effect on the brittleness of the foams, so the optimum isocyanate index can vary depending on the exact performance profile required of the rigid PUR/PIR foams C.

The present invention further provides the rigid PUR/PIR foams C obtainable using the process of the present invention.

The rigid PUR-PIR foams C of the present invention are produced by processes known to one skilled in the art. Examples are described in U.S. Pat. No. 2,764,565, in G. Oertel (ed.) “Kunststoff-Handbuch”, volume VII, Carl Hanser Verlag, 3^{rd} edition, Munich 1993, pages 267 to 354, and also in K. Uhlig (ed.) “Polyurethan Taschenbuch”, Carl Hanser. Verlag, 2^{nd} edition, Vienna 2001, pages 83-102.

It is generally advantageous to foam the individual components against a suitable covering layer. In this embodiment, the invention provides a process wherein the foaming is carried out against at least one covering layer D to form a composite element E comprising said rigid polyurethane-polyisocyanurate foam C and at least one covering layer D. Preferred materials for covering layer D are selected from the group consisting of: concrete, wood, pressboard, aluminum, copper, steel, stainless steel and plastic. Preferred plastics are acrylonitrile-butadiene-styrene copolymers, polyethylene, polystyrene, polyvinyl chloride and polypropylene. The type of covering layer D is not subject to any in-principle restriction; moldings, engineered elements from building construction, pipes, housing parts and so on can be concerned.

The present invention further provides the composite elements E thus obtainable. These may comprise two or more, especially two, covering layers, between which the rigid PUR/PIR foam C is located. Such sandwich composite elements made up of two covering layers and an in-between core layer of the rigid PUR-PIR foam C of the present invention can be, for example, panels (used in factory buildings, for example) or pipes (used in the transportation of district heat, for example) or housings of hot-water boilers. In the case of panels, the two covering layers preferably consist of aluminum, copper, steel, stainless steel, wood or concrete, although the two covering layers need not necessarily be made of the same material. In the case of pipes, it is preferable to have a composite made up of an inner pipe (the inner covering layer) of metal (preferably one of the abovementioned metals), followed by a layer of the rigid PUR/PIR foam C of the present invention (a core layer), followed by a pipe wrapper of a thermoplastic material (the outer covering layer). Housings of hot-water boilers preferably comprise a composite formed from a metal shell (preferably in one of the abovementioned metals), the rigid PUR/PIR foam C of the present invention and the outer housing of a metal (preferably one of the abovementioned metals) or a thermoplastic material.

The production of such composite elements E is known per se and has been extensively described. It takes the form of continuous or batch methods, depending on the field of use.

### EXAMPLES

The examples which follow illustrate the invention. The following methods of analysis were used:

Hydroxyl number: DIN 53240 (December 1971)

Acid number: to DIN EN ISO 2114 (June 2002)

Adherence of foam to metal faces: The determination is carried out on metal-foam sandwich composite elements having an upper and a lower metallic covering layer in accordance with German standard specification DIN EN 14509 as at February 2007: The test specimens for the transverse tensile test are cut in the size of 100 mm×100 mm out of the composite element and are pulled apart in the test vertically to the covering layer plane at a speed of 10 mm/min until the foam or the adherence between the foam and the covering layer fails. To promote proper engagement of the tensile forces, the covering layers are fitted with adhesive-secured metal yokes (eyeleted metal sheets covering all of the foam area) which are then clamped into the tester. For a given cross section, the adherence of the two covering layers (top and bottom) is measured individually in each case. For this, a test specimen having a thickness of 15 mm is cut out of both sides of the composite element and adhered to the yoke at the cover-layer side and the foam-side. The tensile force is applied here at a speed of 5 mm/min to determine the stress at break.

Ratio of primary to secondary OH end groups: determined by ¹H NMR spectroscopy (Bruker DPX 400, deuterochloroform).

Fiber time: Fiber time (“gel point t_{G}”) is determined by briefly dipping a wooden stick into the reacting polymeric melt, and characterizes the time at which the polymeric melt starts to set. The reported to is the time at which it is first possible to draw out strings between the wooden stick and the polymeric melt.

### Example 1

### Preparing a Polyester Polyol Having Exclusively Primary Hydroxyl End Groups as Comparator—Polyol 1

A 10-liter 4-neck flask equipped with heating jacket, mechanical stirrer, internal thermometer, 40 cm packed column, column head, descending high-intensity condenser and also diaphragm vacuum pump was initially charged with 552.4 g (8.9 mol) of ethylene glycol and 6560 g (48.96 mol) of technical-grade glutaric acid under nitrogen blanketing, followed by heating to 200° C. in the course of 3 hours with stirring while water distilled off at a head temperature of 100° C. The internal pressure was then gradually lowered to 100 mbar in the course of 3 hours to complete the reaction in the course of a further 8 hours. After cooling, the following properties were determined:

Analysis of Polyol 1:

Hydroxyl number: 221 mg KOH/g

Viscosity (20° C.): 1980 mPa s

Molar ratio of primary to secondary OH end groups [mol/mol]: 100/0

Owing to its method of making, polyol 1 had a functionality of 2.

### Example 2

### Preparing a Polyol Having Predominantly Secondary Hydroxyl End Groups A1a (Step (I) of Inventive Process)—Polyol 2

(i) Preparing the Polyester Comprising Carboxyl End Groups

A 10-liter 4-neck flask equipped with heating jacket, mechanical stirrer, internal thermometer, 40 cm packed column, column head, descending high-intensity condenser and also diaphragm vacuum pump was initially charged with 1887.6 g (17.8 mol) of diethylene glycol, 552.4 g (8.9 mol) of ethylene glycol and 6560 g (48.96 mol) of technical-grade glutaric acid under nitrogen blanketing, followed by heating to 200° C. in the course of 3 hours with stirring while water distilled off at a head temperature of 100° C. The internal pressure was then gradually lowered to 100 mbar in the course of 3 hours to complete the reaction in the course of a further 8 hours. After cooling, the following properties were determined:

Acid number: 315 mg KOH/g

Viscosity: 140 mPa s (75° C.), 520 mPa s (50° C.), 3530 mPa s (25° C.)

(ii) Reacting the Polyester Comprising Carboxyl End Groups with Propylene Oxide

A 1-1 stainless steel reactor was initially charged with 300.0 g of the polyester carboxylate from (i) and also 0.485 g (1000 ppm based on the overall batch) of N-methyldiethanolamine under protective gas (nitrogen), followed by heating to 125° C. Then, 184.5 g of propylene oxide were added during 60 minutes. Following a post-reaction time of 180 minutes at 125° C. under agitation, volatiles were distilled off at 90° C. (1 mbar) and the reaction mixture was then cooled to room temperature. The following properties were determined:

Analysis of Polyol 2:

Hydroxyl number: 220 mg KOH/g

Acid number; 0.02 mg KOH/g

Viscosity (25° C.): 1193 mPas

Molar ratio of primary to secondary OH end groups [mol/mol]: 37/63

Owing to its method of making, polyol 2 had a functionality of 2.

### Example 3

### Production of Rigid PUR/PIR Foams

These polyols from Examples 1 and 2 were used to produce rigid PUR/PIR foams in the laboratory. To this end, the respective polyol 1/2 was admixed with further polyols 3 and 4 as well as flame retardant, foam stabilizer, catalyst, water and blowing agent. The following materials were used:
polyol 3: polyether polyol based on propylene oxide having a hydroxyl number of 440 mgKOH/g, a functionality of 2.8 and a viscosity of 440 mPas at 25° C. (A1b(I) in the terminology of this application).
polyol 4: polyether polyol based on ethylene oxide/propylene oxide with ethylene oxide end block having a hydroxyl number of 28 mg KOH/g, a functionality of 2 and a viscosity of 860 mPas at 20° C. (A1b(II) in the terminology of this application).
TEP: triethyl phosphate, flame retardant (Lanxess AG).
Tegostab B 8461: foam stabilizer (Evonik).
Desmorapid DB: N,N-dimethylbenzylamine, catalyst (Lanxess AG).
Desmorapid 1792: N,N-dimethylcyclohexylamine, catalyst (Bayer MaterialScience AG).
c-pentane: cyclopentane, blowing agent
isocyanate: mixture of MDI and PMDI having a 4,4′-2-core fraction of about 35% by mass, a 2,4′-2-core fraction of about 4% by mass, a 2,2′-2-core fraction of about 0.5% by mass, a 3-core fraction of about 25% by mass, and also having a higher homolog fraction of about 35% by mass, an NCO value of about 31.5% by mass and a viscosity of about 290 m Pas at 20° C. (“Desmodur® 44V20L, BMS AG”).

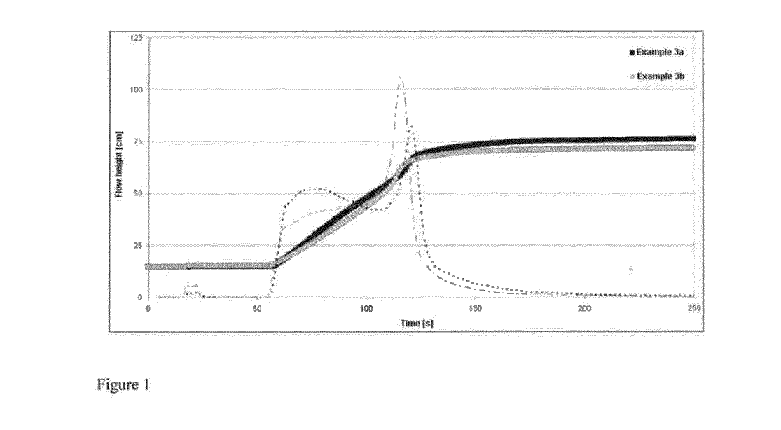

The isocyanate-reactive composition thus obtained was mixed with the isocyanate and poured into a mold. The mixture itself was prepared with a stirrer at 1000 rpm and 23° C. raw-material temperature. The exact recipes including the results of appropriate physical tests are summarized in table 1. Polyol 1 was used in Example 3a and polyol 2 in Example 3b. FIG. 1 shows the rise profiles for both foams. The curves are plots of the flow heights (black squares for Example 3a, gray circles for Example 3b) and the rates of rise (1^{st} derivation, broken lines; Example 3a in black ink, Example 3b in gray ink) against the time.

The apparent densities reported in table 1 were determined on a 1000 cm³ cube (edge length 10 cm) by determining the corresponding mass. The flow behavior to assess the rise profile of the respective foams was measured in a heatable riser tube (diameter=9.1 cm) at atmospheric pressure and 35° C.

TABLE 1
Results from Example 3

| | | Example 3a | Example 3b |
|---|---|---|---|
| | | (comparator) | (invention) |
| Component | Unit | Value | |
| polyol 1 (100 mol % | parts by weight | 57.0 | 0 |
| primary OH end groups) | | | |
| polyol 2 (37 mol % primary | parts by weight | 0 | 57.0 |
| OH end groups) | | | |
| polyol 3 | parts by weight | 13.0 | 13.0 |
| polyol 4 | parts by weight | 13.0 | 13.0 |
| TEP | parts by weight | 15.0 | 15.0 |
| water | parts by weight | 1.6 | 1.6 |
| Tegostab B8461 | parts by weight | 2.0 | 2.0 |
| Desmorapid DB | parts by weight | 0.8 | 0.8 |
| Desmorapid 1792 | parts by weight | 2.0 | 2.0 |
| c-pentane | parts by weight | 13.0 | 13.0 |
| isocyanate | parts by weight | 238 | 248 |
| isocyanate index | | 320 | 320 |
| free apparent density | kg/m³ | 32.8 | 33.3 |
| fiber time (“gel point t_{G}”) | s | 118 | 113 |
| foam height at t_{G} | cm | 62.6 | 55.8 |
| core apparent density | kg/m³ | 62.6 | 61.0 |
| adhesive strength*) | N/mm² | 0.328 | 0.457 |

*) as measured at the upper covering layer

Table 1 shows that replacing polyol 1 having 100 mol % primary hydroxyl end groups by polyol 2 having merely 37 mol % primary hydroxyl end groups does not affect the density of the uncompressed rigid PUR/PIR foam. Free apparent densities of 33.3 kg/m³ and 32.8 kg/m³, respectively, must be considered equal within the experimental error. However, the lower foam height at gel point in Example 3b versus Example 3a indicates a different flow behavior of the foam matrix during the foaming operation.

As is apparent from FIG. 1, the plot of the rate of rise against time has two maxima in the case of Example 3a. The introductorily described problematics of a nonuniform reaction profile become particularly clear here. First the exothermic urethane formation (PUR reaction) takes place, which causes the reaction mixture to heat up, as evidenced by the first maximum at about 70 seconds. Starting at a temperature of about 65° C., the trimerization of the isocyanates, the so-called PIR reaction, ensues, as evidenced by the second maximum at about 120 seconds.

Example 3b, by contrast, has only one maximum for the rate of rise at about 115 seconds (with a preceding “shoulder”). In this case, the adhesive strength at 0.457 N/mm² is significantly greater than that of Example 3a at 0.328 N/mm². In Example 3b, use of polyol 2 according to the present invention has succeeded in uniformizing the course of the PUR and PIR reactions, which is reflected in a monotonous increase in the foaming pressure (apparent from the course of the rate of rise) and uniform flow of the foam.

What is claimed is:

1. A process for producing a rigid polyurethane-polyisocyanurate foam C comprising the steps of
(I) reacting a polyester comprising carboxyl end groups with an epoxide of general formula (1), 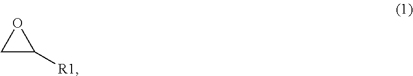
where R1 represents alkyl or aryl,
by obeying a molar ratio of epoxy groups to carboxyl end groups at between 0.8:1 and 50:1, to obtain a polyester polyol having secondary hydroxyl end groups A1a which has a functionality of 1.8 to 6.5, and a hydroxyl number of 15 mg KOH/g to 500 mg KOH/g;
(II) foaming at isocyanate indexes of 180 to 400,
(i) a polyol component A1 comprising A1a
with
(ii) an isocyanate component B comprising
a) at least one isocyanate B1 selected from the group consisting of:
tolylene diisocyanate, diphenylmethane diisocyanate, polyphenylene polymethylene polyisocyanate, xylylene diisocyanate, naphthylene diisocyanate, hexamethylene diisocyanate,
diisocyanatodicyclohexylmethane and isophorone diisocyanate,
or
b) an isocyanate-terminated prepolymer B2 prepared from at least a polyisocyanate B1 and an isocyanate-reactive compound,
or
c) mixtures of B1 and B2,
in the presence of
(iii) at least one blowing agent A2, and
(iv) at least one catalyst A3, except that carbanionic catalysts shall be excluded.

2. The process as claimed in claim 1 wherein said polyol component A1 in addition to said polyester polyol having secondary hydroxyl end groups A1a comprises at least one aliphatic polyether polyol A1b having a hydroxyl number between 15 mg KOH/g and 500 mg KOH/g and a functionality of 1.5 to 5.5.

3. The process as claimed in claim 1 or 2 wherein the polyester comprising carboxyl end groups is obtained from the reaction of
(i) at least one alcohol selected from the group consisting of
ethylene glycol, diethylene glycol, polyethylene glycol, 1,2-propylene glycol, dipropylene glycol, 1,3-propanediol, 1,4-butanediol, 1,6-hexanediol, 1,8-octanediol, 1,10-decanediol, 1,12-dodecanediol, 2-methyl-1,3-propanediol, neopentyl glycol, 3-methyl-1,5-pentanediol, glycerol, pentaerythritol and 1,1,1-trimethylolpropane,
with
(ii) at least one carboxylic acid equivalent selected from the group consisting of
succinic acid, fumaric acid, maleic acid, maleic anhydride, glutaric acid, adipic acid, sebacic acid, 1,10-decanedicarboxylic acid, 1,12-dodecanedicarboxylic acid, phthalic acid, phthalic anhydride, isophthalic acid, terephthalic acid, pyromellitic acid, trimellitic acid and caprolactone.

4. The process as claimed in any of claims 1 to 3 wherein R1 in general formula (1) is
methyl, ethyl, n-propyl, isopropyl, n-butyl, sec-butyl, isobutyl, tert-butyl, cyclohexyl or phenyl.

5. The process as claimed in any of claims 1 to 4 wherein said polyester polyol having secondary hydroxyl end groups A1a is prepared in the presence of at least one catalyst selected from:
(i) amines of general formula (2): 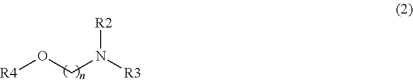
where
R2 and R3 are each independently hydrogen, alkyl or aryl;
or
R2 and R3 combine with the nitrogen atom bearing them to form an aliphatic, unsaturated or aromatic heterocycle;
n is an integer from 1 to 10;
R4 is hydrogen, alkyl or aryl; or
R4 represents —(CH₂)ₓ—N(R41)(R42), where:
R41 and R42 are each independently hydrogen, alkyl or aryl; or
R41 and R42 combine with the nitrogen atom bearing them to form an aliphatic, unsaturated or aromatic heterocycle;
x is an integer from 1 to 10;
or
(ii) amines of general formula (3): 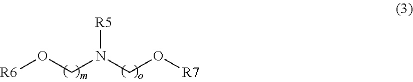
where
R5 is hydrogen, alkyl or aryl;
R6 and R7 are each independently hydrogen, alkyl or aryl;
m and o are each independently an integer from 1 to 10;
or
(iii) nitrogen compounds selected from the group consisting of:
diazabicyclo[2.2.2]octane, diazabicyclo[5.4.0]undec-7-ene, dialkylbenzylamine, dimethylpiperazine, 2,2′-dimorpholinyldiethyl ether, pyridine;
or
(iv) mixtures of catalysts from two or more of groups (i) to (iii).

6. The process as claimed in claim 5 wherein in general formula (2)
R2 and R3 are each methyl, R4 is hydrogen and n is =2, or
R2 and R3 are each methyl, R4 is —(CH₂)₂—N(CH₃)₂ and n is =2, and wherein in general formula (3)
R5 is methyl, R6 and R7 are each hydrogen, m is =2 and o is =2.

7. The process as claimed in any of claims 1 to 6 wherein the preparation of the polyester comprising carboxyl end groups which is used in step (I) comprises the steps of:
(i) condensing at least one alcohol selected from the group consisting of
ethylene glycol, diethylene glycol, polyethylene glycol, 1,2-propylene glycol, dipropylene glycol, 1,3-propanediol, 1,4-butanediol, 1,6-hexanediol, 1,8-octanediol, 1,10-decanediol, 1,12-dodecanediol, 2-methyl-1,3-propanediol, neopentyl glycol, 3-methyl-1,5-pentanediol, glycerol, pentaerythritol and 1,1,1-trimethylolpropane,
with
at least one carboxylic acid equivalent selected from the group consisting of
succinic acid, fumaric acid, maleic acid, maleic anhydride, glutaric acid, adipic acid, sebacic acid, 1,10-decanedicarboxylic acid, 1,12-dodecanedicarboxylic acid, phthalic acid, phthalic anhydride, isophthalic acid, terephthalic acid, pyromellitic acid, trimellitic acid and caprolactone,
while choosing the molar ratio of alcohol(s) to carboxylic acid equivalent(s) such that a process product having terminal alcohol groups is obtained;
(ii) reacting the process product obtained in (i) with at least one carboxylic anhydride selected from the group consisting of
phthalic anhydride, maleic anhydride, glutaric anhydride and succinic anhydride.

8. The process as claimed in claim 7 wherein step (i) is carried out at a temperature T(i) of 150° C. to 250° C. and step (ii) is carried out at a temperature T(ii) of 120° C. to 250° C.

9. The process as claimed in any of claims 1 to 8 wherein step (II) is carried out in the presence of
(v) at least one flame retardant A4, and
(vi) at least one foam stabilizer A5,
by first
preparing an isocyanate-reactive composition A comprising said components A1 to A5 by mixing said components in any desired order in an A:A2 mass ratio of 2.5:1 to 25:1, and then
foaming up said isocyanate-reactive composition A with said isocyanate component B to form said rigid polyurethane-polyisocyanurate foam C.

10. The process as claimed in any of claims 1 to 9 wherein said catalyst A3 is selected from the group consisting of:
triethylenediamine, N,N-dimethylcyclohexylamine, tetramethylenediamine, 1-methyl-4-dimethylaminoethylpiperazine, triethylamine, tributylamine, dimethylbenzylamine, dicyclohexylmethylamine, N,N′,N″-tris(dimethylamino-propyl)hexahydrotriazine, tris(dimethylaminopropyl)amine, tris(dimethylaminomethyl)phenol, dimethylaminopropylformamide, N,N,N′,N′-tetramethylethylenediamine, N,N,N′,N′-tetramethylbutanediamine, tetramethylhexanediamine, pentamethyldiethylenetriamine, pentamethyldipropylenetriamine, tetramethyldiaminoethyl ether, dimethylpiperazine, 1,2-dimethylimidazole, 1-azabicyclo[3.3.0]octane, bis(dimethylaminopropyl)urea, N-methylmorpholine, N-ethylmorpholine, N-cyclohexylmorpholine, 2,3-dimethyl-3,4,5,6-tetrahydropyrimidine, triethanolamine, diethanolamine, triisopropanolamine, N-methyldiethanolamine, N-ethyldiethanolamine, dimethylethanolamine, tin(II) acetate, tin(II) octoate, tin(II) ethylhexoate, tin(II) laurate, dibutyltin diacetate, dibutyltin dilaurate, dibutyltin maleate, dioctyltin diacetate, tris(N,N-dimethylaminopropyl)-s-hexahydrotriazine, tetramethylammonium hydroxide, sodium N-[(2-hydroxy-5-nonylphenyl)methyl]-N-methylaminoacetate, sodium acetate, sodium octoate, potassium acetate, potassium octoate and sodium hydroxide,
and wherein said blowing agent A5 is selected from the group consisting of:
water, cyclopentane, n-pentane, isopentane, hydrofluorocarbons and partially halogenated alkenes having 3 or 4 carbon atoms.

11. The process as claimed in any of claims 1 to 10 wherein the foaming step utilizes a polyester polyol A1a in which the molar ratio of primary hydroxyl end groups to secondary hydroxyl end groups is between 0:1 and 1:1.

12. A rigid polyurethane-polyisocyanurate foam C obtainable by a process as claimed in any of claims 1 to 11.

13. The process as claimed in any of claims 1 to 11 wherein the foaming is carried out against at least one covering layer D to form a composite element E comprising said rigid polyurethane-polyisocyanurate foam C and at least one covering layer D.

14. The process as claimed in claim 13 wherein said covering layer D consists of a material selected from the group consisting of:
concrete, wood, pressboard, aluminum, copper, steel, stainless steel and plastic.

15. A composite element E obtainable by a process as claimed in either of claims 13 and 14.
